(19) United States
(12) Patent Application Publication
(10) Pub. No.: US 2008/0056878 A1
(43) Pub. Date: Mar. 6, 2008

(54) Storage module for flat postal items with last-in/first-out operation

(75) Inventors: Holger Schererz, Rehfelde (DE); Armin Zimmermann, Konstanz (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/825,454

(22) Filed: Jul. 6, 2007

(30) Foreign Application Priority Data
Jul. 7, 2006 (DE) 10 2006 031 891.9

(51) Int. Cl. B65G 57/11

(52) U.S. Cl. 414/802; 414/788.1

(57) ABSTRACT

In order to reduce fault susceptibility of a stacking device for flat mailings, a stack of mailings is arranged between a stacking roll driven in a closed-loop or open-loop controlled manner and a stack support movable in a closed-loop or open-loop controlled manner such that a mailing is arranged in a vertical desired position relative to an under floor belt. An inclined position, deviating in relation to the desired position, of at least one of the mailings is detected by a detector device. The inclined position is corrected by a closed-loop controlled or open-loop controlled acceleration of at least one of the under floor belt and of the stack support.

### BACKGROUND OF THE INVENTION

The present invention relates to a method and to a stacking device for stacking flat mailings.

Stacking devices and methods for stacking flat mailings find application in particular in automatic sorting facilities for postal mailings, in particular in letter sorting facilities. A stacking device is disclosed in international patent application WO 03/099692, in which flat mailings are interpolated via a stacking roll between the stacking roll and a movable stack support. Each mailing is herewith inserted into the stack such that it lies with a narrow edge on an under floor belt driven in an open-loop controlled manner. The goods are oriented toward the front edge. That means that the mainly rectangular goods are aligned to the bottom edge and the front edge. The stack grows as further mailings are inserted between the stacking roll and the mailing lying closest to the stacking roll. In order to be able to insert a new mailing, the under floor belt is advanced the width of one item in a direction away from the stacking roll. As a result, however, the stack or a part of the stack can tilt out of the desired position perpendicular to the under floor belt. On the one hand, mailings can fall out of the stack and cause a jam. On the other, the entry of further mailings in the stack can also be prevented. It is precisely in modern stacking equipment in which the entry in a stack is dependent on the presence of a precise stack pressure that a slight tilting of individual mailings can lead to the breakdown or major disruptions in the stacking process.

In known stacking devices, the letter stack or a part of the letter stack or an individual mailing has therefore to be prevented from starting to tilt under the influence of gravity or of mass inertia and thereby adversely affecting the pressure conditions necessary for entry in the stack.

To solve this problem, EP 0 868 227 B1 discloses a device and a method for the intermediate stacking of mailings in which a tilting of the stack is corrected by a movement of the under floor belt or of a stacking carriage. In order to monitor the process, EP 0 868 227 B1 proposes an open-loop control.

The problem of the tilting of stacks acquires greater significance in particular in the stacking of mailings having large differences in format. If, for example, provided all the mailings are rectangular and have a homogeneous mass distribution, the ratio of the largest format to the smallest format is greater than 2, then the center of gravity of a large mailing will already be above the highest point of the smallest mailing, as a result of which the stack can tilt particularly easily. The problem is additionally increased in realistic situations by uneven distributions of the mass of mailings and by conical mailings. Furthermore, in modern stacking equipment, it has to be possible for part of the stack to be removed, while further mailings are simultaneously entered in the stack.

### SUMMARY OF THE INVENTION

The object of the present invention is therefore to reduce the susceptibility to faults of a stacking device for flat mailings.

According to the invention, the stacking device comprises a stacking roll, a stack support movable in a closed-loop controlled manner, an under floor belt driven in a closed-loop controlled manner, a control device and a detector device. A stack can be interpolated between the stacking roll and the stack support in a supported manner such that a mailing is stacked in a desired position upright relative to an under floor belt, preferably in a desired position perpendicular to an under floor belt. An inclined position, deviating in relation to the desired position, of a mailing can be detected by the detector device. The control device is fashioned and connected to the under floor belt and stack support such that the inclined position can be corrected by means of an acceleration of the stack support and/or of the under floor belt.

Within the scope of the method according to the invention, a stack of mailings is interpolated between a stacking roll and a movable stack support such that a mailing is disposed in a desired position upright relative to an under floor belt. The mailings are preferably disposed in a desired position perpendicular to an under floor belt. An inclined position, deviating in relation to the desired position, of at least one of the mailings is detected by a detector device. The inclined position is corrected by a closed-loop controlled acceleration of the under floor belt and/or stack support.

Within the scope of this document, the term acceleration is to be understood in the physical sense. This means that the colloquially used term “brake” also falls under the term “accelerate”.

An inclined position in which the stack is tilted with the top edge of the at least one mailing toward the stacking roll is corrected by the acceleration of the under floor belt in a direction toward the stacking roll and/or by the acceleration of the stack support toward the stacking roll.

An inclined position in which the stack is tilted with the top edge of the at least one mailing away from the stacking roll is corrected by the acceleration of the under floor belt in a direction away from the stacking roll and/or by the acceleration of the stack support toward the stacking roll.

Where the stacking roll is stationary, in particular where the stacking roll cannot execute any translatory movements parallel to the under floor belt, an easily producible detector device comprising just one sensor can be realized. If, for example, the distance from the sensor to the stack in a direction parallel to the under floor belt is measured as a characteristic variable, then an inclined position can be detected if a measured distance deviates from a desired distance. This is provided that the stack is constantly in contact with the stacking roll.

For most applications, a translatory displaceable stacking roll is advantageous, particularly in a direction parallel to the under floor belt. In this way, for example, a random compressibility of a mailing which is inserted in the stack via the stacking roll can be compensated. An easily producible and reliable detector device can in this case be realized by means of two sensors, by each of which a characteristic variable of the stack is measured. For example, the distance from the respective sensor to the stack can be measured from each of the two stationary distance sensors. If the difference of the distances deviates from a desired difference, then an inclined position and in particular a direction of inclination of a mailing, can be concluded.

In some stacking devices, awareness about a stack pressure, in particular about the pressure of the stacking roll on the stack, is used in order to move the under floor belt by a distance to be determined and thereby create space for a mailing to be newly inserted. The pressure sensor necessary for doing this can be used as a component in the detector device in order in addition to detect an inclined position of the stack or of a part of the stack. By this means the stacking device can be more highly integrated.

A further advantageous embodiment is produced if, viewed from the stacking roll, a conveyor plate is arranged behind the under floor belt. In this way, even for long stacks, only a short under floor belt is needed. A part of the stack can then lie with the narrow edges of the mailings on the under floor belt while the remaining part lies on the conveyor plate. It has been shown in tests that, when mailings are entered in a stack via the stacking roll, the stack tends to tilt in particular in the front-most area, i.e., in the area lying closest to the stacking roll. In such situations, while the tilted front area of the stack can be compensated by acceleration of the under floor belt, the rear area of the stack which was not, or was only to a very limited extent, tilted from its desired position, can however tilt as a result of the acceleration. This problem can be solved by a shorter under floor belt in combination with a connecting conveyor plate. While on the under floor belt the mailings are often accelerated intermittently, a more even movement is produced on the conveyor plate. Also, the pressure on the stacking roll is determined mainly by the under floor belt. By limiting the under floor belt to the area of the stacking roll, when part of the stack is removed in the region of the conveyor plate, only a small effect is produced on an incoming stacking process taking place simultaneously at the stacking roll.

It is desirable for the conveyance of mailings on the conveyor plate to have as little effect as possible on the pressure conditions in the remaining part of the stack. This can be achieved whereby the conveyor plate is fashioned as an inclined plane, the end of the conveyor plate further away from the stacking roll lying lower than the end closer to the stacking roll.

For the same reason, it can be advantageous for the conveyor plate to be executed as a roller track or as a passive under floor belt and/or to coat the conveyor plate with an anti-adhesive agent, preferably Teflon.

An inclined position can have disastrous effects for the stacking of mailings in particular where the particular mailing in the stack is affected which lies closest to the stacking roll, since in this case the interpolation of further mailings via the stacking roll mailings can be damaged. Detecting and correcting the inclined position of the mailing closest to the stacking roll, prevents damaging mailings.

### BRIEF DESCRIPTION OF THE SEVERAL VIEWS OF THE DRAWINGS

The invention will be explained in detail below with reference, for example, to the figures, in which:

FIG. 1 shows a stacking device for stacking flat mailings in a first embodiment of the invention, and

FIG. 2 shows a stacking device for stacking flat mailings in a second embodiment of the invention.

### DETAILED DESCRIPTION OF THE INVENTION

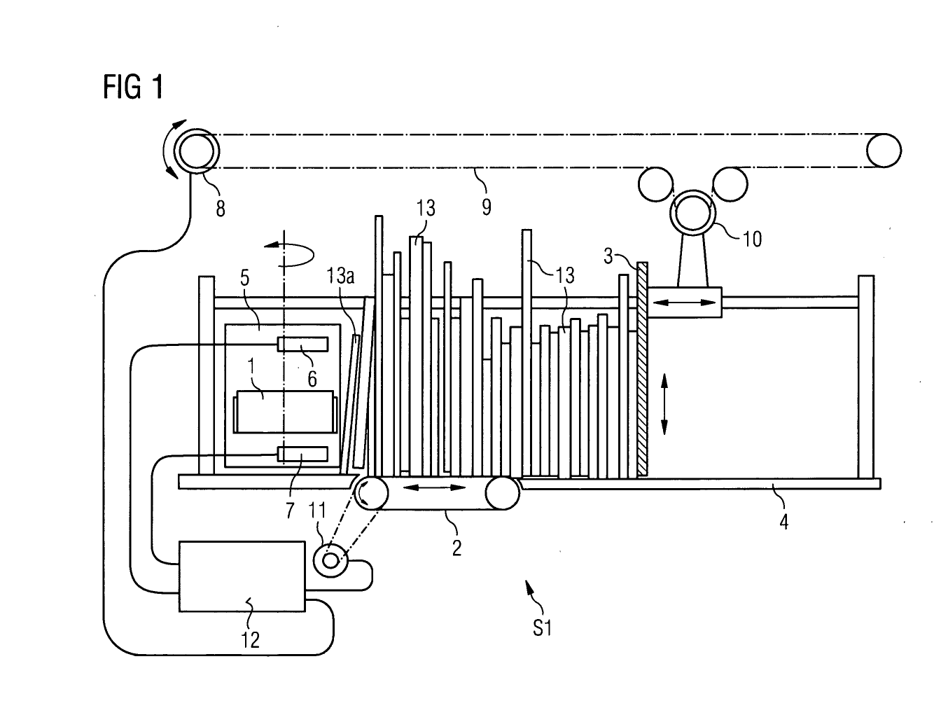

FIG. 1 shows a first embodiment of the invention using a stacking device S1 for stacking flat mailings 13. The stacking device S1 comprises a stacking roll 1, a stack support 3 movable in a closed-loop controlled manner, an under floor belt 2 driven in a closed-loop controlled manner, a conveyor plate 4 which connects to the under floor belt, a detector device 5 and a control device 12. A stack of mailings 13, 13a is entered in a stack between the stacking roll 1 and the stack support 3. A part of the stack lies with the narrow edges of the mailings on the under floor belt 2, while the remaining part lies with the narrow edges of the mailings on the conveyor plate 4.

The stacking roll 1 is translator sprung parallel to the under floor belt 2. New mailings can be entered in the stack via the stacking roll 1, the stack growing as a result. The stack support 3 is therefore connected to a moving device 14, by means of which the stack support 3 can be moved parallel to the under floor belt 2 and perpendicular to the under floor belt 2. The parallel movability serves to take account of changes in the size of the stack, while the vertical movability serves to lift the stack support 3 out of the stack and/or to insert it again at another point. The vertical movability serves for example in enabling partial removals of the stack or in subdividing the stack.

The movement device 14 comprises a main drive 8 which is responsible for the movability parallel to the under floor belt 2, a secondary drive 10 which is responsible for the movability perpendicular to the under floor belt 2 and a toothed-belt system 9.

The detector device 5 comprises two sensors 6, 7 which are arranged above and below the stacking roll 1. The sensors 6, 7 are fashioned as optical distance-measuring devices which measure the distance from the respective sensor 6, 7 to the stack in a direction parallel to the under floor belt 2. The distance to the stack is measured whereby the distance to the mailing 13a lying closest to the stacking roll 1 is measured. The two sensors 6, 7 have identical desired distances to the stack, since the sensors 6, 7 are arranged above one another.

In the stack shown in FIG. 1, those mailings which are closest to the stacking roll 1 are tilted with their top edge away from the stacking roll 1. The inclined position of the particular mailing which lies closest to the stacking roll 1 is detected by the sensors 6, 7 measuring different distances to the stack. The sensors 6, 7 forward the measured values to the control device 12. The control device 12 controls the under floor belt 2 and the stack support 3 such that the inclined position is corrected by means of an acceleration of the stack support 3 and of the under floor belt 2. In the example shown in FIG. 1, this is effected by means of an acceleration of the under floor belt 2 in a direction away from the stacking roll 1 and of the stack support 3 toward the stacking roll 1 until the inclined position is corrected and/or the desired stack pressure is reached. In order to drive the under floor belt 2, the control device 12 is connected to a drive 11.

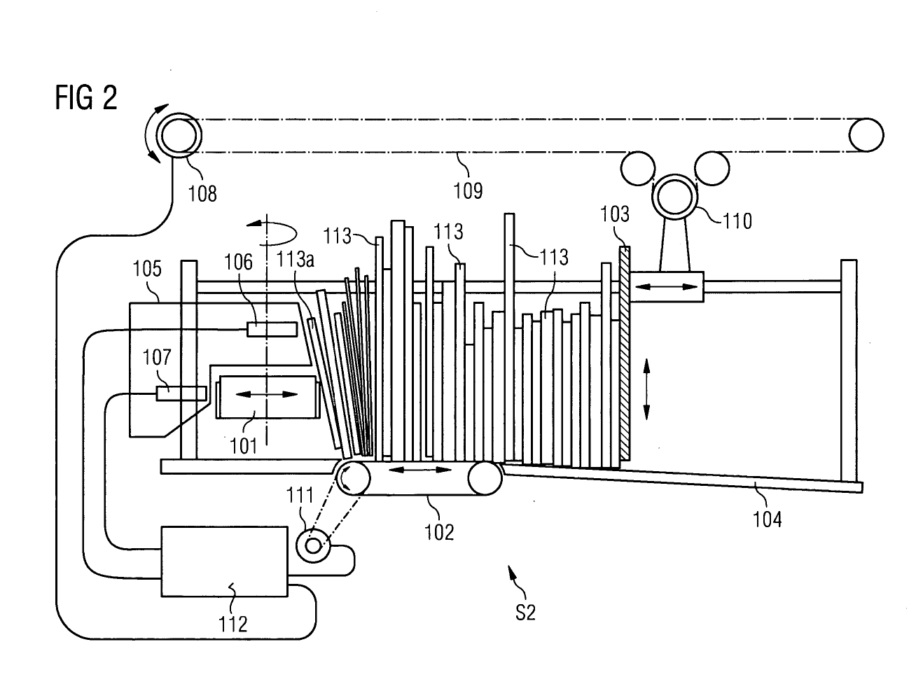

FIG. 2 shows a second embodiment of the invention with a stacking device S2 for stacking flat mailings 113, 113a. Like the first embodiment, the second embodiment also comprises a stacking roll 101, a stack support 103 movable in a closed-loop controlled manner, an under floor belt 102 driven in a closed-loop controlled manner, a conveyor plate 104 which is connected to the under floor belt 102, a detector device 105 and a control device 112. The detector device 105 comprises two sensors 106, 107 for distance measurement. The stack support 103 is driven by a movement device 114 which can be fashioned exactly like the movement device 14 shown in FIG. 1, i.e., analogously with a main drive 108, a secondary drive 110 and a toothed-belt system 109. In order to drive the under floor belt, the control device 112 is connected to a drive 111.

The sensor 106 is arranged above the stacking roll 1. Unlike FIG. 1, in the detector device 105, the sensor 107 is arranged behind the stacking roll 101. The sensor 106 measures the distance to the stack, while the sensor 107 measures the distance to the stacking roll 101 which is spring-mounted in a direction parallel to the under floor belt 102. A deviation from a desired difference between two distances measured simultaneously by the sensors 106, 107 will be interpreted by the control device 112 as an inclined position of the mailing 113a in the stack lying closest to the stacking roll (1, 101).

A further difference in relation to the embodiment shown in FIG. 1 is the conveyor plate 114, which is fashioned as an inclined plane, the end of the conveyor plate 104 further away from the stacking roll 101 lying lower than the end closer to the stacking roll 101. By this means, mailings which lie on the conveyor plate 104 can be transported away from the stacking roll more easily.

In the stack shown in FIG. 2, those sensors which are closest to the stacking roll 1 are tilted with their top edge toward the stacking roll 1. This inclined position in a direction toward the stacking roll 1 is detected by the detector device 105 and processed by the control device 112. The control device 112 controls the under floor belt 102 and the stack support 103 such that the inclined position is corrected by means of an acceleration of the stack support 103 and of the under floor belt 102. In the example shown in FIG. 2, this is effected by means of an acceleration of the under floor belt 102 in a direction toward the stacking roll 101. A deviation from the desired stack pressure and/or a gap which can establish itself as a result in the central area of the stack is corrected by an acceleration of the stack support 103 toward the stacking roll 101.

List of Reference Characters Used

1, 101 stacking roll, stack entry roll

2, 102 under floor belt

3, 103 stack support

4, 104 conveyor plate

5, 105 detector device

6, 106 sensor

7, 107 sensor

8, 108 main drive

9, 109 tooth-belt drive

10, 110 secondary drive

11, 111 drive for the under floor belt

12, 112 control device

13, 113 mailings

14, 114 movement device

S1, S2 stacking device

What is claimed is:

1. A method of stacking flat mailings, comprising:
interpolating a stack of mailings between a stacking roll driven in a closed-loop or open-loop controlled manner and a stack support movable in a closed-loop or open-loop controlled manner, wherein a mailing is arranged in a desired position upright relative to an under floor belt;
detecting an inclined position of at least one of the mailings, said position deviating in relation to the desired position, by a detector device; and
correcting the inclined position by a closed-loop controlled acceleration of at least one of the under floor belt and the stack support.

2. The method of claim 1, wherein the desired position of the mailing is perpendicular to the under floor belt.

3. The method of claim 1, wherein an inclined position in which the mailing is tilted with a top edge toward the stacking roll is corrected by accelerating at least one of the under floor belt in a direction toward the stacking roll and the stack support toward the stacking roll.

4. The method of claim 1, wherein an inclined position in which the mailing is tilted with a top edge away from the stacking roll is corrected by accelerating at least one of the under floor belt in a direction away from the stacking roll and the stack support toward the stacking roll.

5. The method of claims 1, wherein the stacking roll is stationary and the detector device comprises a sensor configured to measure a characteristic variable of the stack.

6. The method of claim 5, wherein the characteristic variable represents at least one of a pressure of the stack on the sensor and a distance of the sensor to the stack.

7. The method of claim 1, wherein the stacking roll is displaceable and the detector device comprises two sensors, by each of which a characteristic variable of the stack is measured.

8. The method of claim 7, wherein the characteristic variables represent one of a pressure of the stack on the respective sensor and a distance of the respective sensor to the stack.

9. The method of claim 7, wherein one of the sensors of the detector device additionally records a stack pressure.

10. The method of claim 1, wherein viewed from the stacking roll, a conveyor plate is arranged behind the under floor belt and a part of the stack lies with narrow edges of the mailings on the under floor belt and a further part of the stack lies with the narrow edges of the mailings on the conveyor plate.

11. The method of claim 10, wherein the conveyor plate is configured as an inclined plane, wherein an end of the conveyor plate further from the stacking roll lies lower than an end closer to the stacking roll.

12. A stacking device for stacking flat mailings comprising:
a stacking roll;
a stack support movable in a closed-loop or open-loop controlled manner;
an under floor belt configured to be driven in a closed-loop controlled manner;
a controlling device; and
a detector device,
wherein between the stacking roll and the stack support a stack is entered in a supported manner such that a mailing is stacked with a desired position upright relative to the under floor belt;
an inclined position, deviating in relation to the desired position, of at least one of the mailings is detectable by the detector device, and
wherein the control device is connected to the under floor belt and the stack support such that the inclined position is correctable by means of an acceleration of at least one of the stack support and the under floor belt.

13. The stacking device of claim 12, wherein the desired position of the mailing is perpendicular to the under floor belt.

14. The stacking device of claim 12, wherein an inclined position in which the stack is tilted with a top edge of a mailing toward the stacking roll, is correctable by acceleration of at least one of the under floor belt in a direction toward the stacking roll and the stack support toward the stacking roll.

15. The stacking device of claim 12, wherein an inclined position in which the stack is tilted with a top edge of a mailing away from the stacking roll, is correctable by acceleration of at least one of the under floor belt in a direction away from the stacking roll and the stack support toward the stacking roll.

16. The stacking device of claim 12, wherein the stacking roll is stationary and the detector device comprises a sensor by which a characteristic variable of the stack can be measured.

17. The stacking device of claim 12, wherein the stacking roll is displaceable, and the detector device comprises two sensors by each of which a characteristic variable of the stack can be measured.

18. The stacking device of claim 12, wherein a stack pressure is detectable by one of the sensors of the detector device.

19. The stacking device of claim 12, wherein viewed from the stacking roll, a conveyor plate is arranged behind the under floor belt and a part of the stack lies on the under floor belt and a further part of the stack lies on the conveyor plate.

20. The stacking device of claim 12, wherein the conveyor plate is configured as an inclined plane, wherein an end of the conveyor plate further from the stacking roll lies lower than an end closer to the stacking roll.
